(19) United States
(12) Patent Application Publication
(10) Pub. No.: US 2023/0001392 A1
(43) Pub. Date: Jan. 5, 2023

(54) STEEL MESH BASED CATALYST WITH SUPERIOR MECHANICAL STABILITY / MAGNETIC SEPARABILITY

(71) Applicant: University of South Carolina, Columbia, SC (US)

(72) Inventors: Jochen Lauterbach, Columbia, SC (US); Michael Royko, Columbia, SC (US)

(73) Assignee: University of South Carolina, Columbia, SC (US)

(21) Appl. No.: 17/781,780

(22) PCT Filed: Dec. 4, 2020
(86) PCT No.: PCT/US2020/063233

§ 371 Date: Jun. 2, 2022

Related U.S. Application Data
(60) Provisional application No. 62/944,427, filed on Dec. 6, 2019.

(51) Int. Cl. B01J 27/25; B01J 21/04; B01J 35/00; B01J 35/06; B01J 37/02; B01J 37/03; B01J 37/08; C01B 3/16

(52) U.S. Cl. CPC B01J 27/25; B01J 21/04; B01J 35/0033; B01J 35/06; B01J 37/0205; B01J 37/036; B01J 37/0236; B01J 37/08; C01B 3/16; C01B 2203/0283; C01B 2203/1076; C01B 2203/1082

(57) ABSTRACT

Described herein are reusable, mesh-based catalysts with superior mechanical stability and magnetic separability wherein the mesh may be formed in a variety of shapes and can be easily separated from a process stream and in combination with biomass torrefaction, reduces toxic emissions and produce hydrogen gas, which can be burned at the facility to generate heat or electricity.

### TECHNICAL FIELD

The subject matter disclosed herein is generally directed to reusable, mesh-based catalysts with superior mechanical stability and magnetic separability. The mesh may be formed in a variety of shapes and can be easily separated from a process stream and in combination with biomass torrefaction. This reduces toxic emissions and produces hydrogen gas, which can be burned at the facility to generate heat or electricity.

### BACKGROUND

Biomass torrefaction is a promising technology that has commercial plants operating both in the United States (over 45,300 kg/hr) and in Europe (over 15,000 kg/hr). In addition to these plants, biomass torrefaction is suitable for most agricultural plant based waste or wood. In many areas, these wastes are burned openly in fields or disposed of in ways that energy is not harvested for heat or electricity generation while still releasing CO₂ emissions.

As torrefaction increases the energy density of post-processed biomass, it is more suitable for transport and direct burning in power generation facilities. Typically the torrefaction gas containing CO is oxidized to form CO₂ via catalytic combustion which produces no value added products and generates little harvestable energy. Carbon monoxide oxidation catalysts are commonly sold for exhaust treatment applications from catalyst companies such as BASF, Catalytic Combustion Corporation, Johnson Matthey, Siemens, etc. Meanwhile, water-gas shift catalysts, also applicable in torrefaction processes, are sold commercially by firms such as AZO Materials (Reformance-WGS), Johnson Matthey (KATALCO and HiFUEL) among others.

What is needed are catalysts that effectively improve energy recoup from torrefaction processes, as well as allow for simplified, yet highly efficient, recovery. Accordingly, it is an object of the present disclosure to provide for catalysts that allow for the generation of hydrogen which can be used for power production, heat generation, or for hydrogenation of CO₂ to produce liquid fuels. These catalysts may also help drive down the cost of the torrefaction process and increase the amount of useful energy created per unit mass of biomass. Additionally, the improved catalysts provided herein may be mechanically mixed with biomass such that a heated exhaust treatment system is not needed, which reduces capital as well as operating costs. Therefore, implementation of catalysts of the current disclosure could encourage the development of the budding torrefaction process by appealing to utility companies.

Citation or identification of any document in this application is not an admission that such a document is available as prior art to the present disclosure.

### SUMMARY

The above objectives are accomplished according to the present disclosure by providing a magnetically separable catalyst. The catalyst may include a magnetic mesh, a catalyst integrated with the magnetic mesh, and the magnetically separable catalyst is specifically shaped under a load to form a final catalyst material that is magnetically active. Further, the catalyst may comprise copper. Again, the catalyst may comprise aqueous copper (II) nitrate trihydrate. Still yet, the catalyst may comprise aqueous copper (II) nitrate trihydrate on alumina powder. Yet, the catalyst may be employed in a water-gas shift reaction at temperatures between 200-300° C. Still further, the magnetic mesh may comprise a specifically shaped mesh. Moreover, the magnetically separable catalyst may be mixed with biomass. Still yet, the catalyst may be shaped around the magnetic mesh. Further yet, the magnetic mesh may be embedded into the catalyst.

In an alternative embodiment, a method is provided for forming a magnetically separable catalyst. The method may include preparing a catalyst powder, wet impregnating the catalyst powder onto a magnetic mesh, reducing solution volume via heating to form a catalyst gel, mechanically integrating the reduced catalyst gel with the magnetic mesh, and drying and calcining the mechanically shaped reduced gel. Again, the method may include using a mold to mechanically integrate the catalyst gel with the magnetic mesh. Yet still, the catalyst may be formed into consistently shaped and sized catalyst pellets. Moreover, the catalyst may comprise aqueous copper (II) nitrate trihydrate on alumina powder. Still more, the method may include mixing the magnetically separable catalyst with biomass. Further, the catalyst gel may be shaped around the magnetic mesh. Still again, the magnetic mesh may be embedded into the catalyst gel. The magnetic mesh may substantially surround a perimeter of the catalyst gel once calcined. Still again, the catalyst powder may comprise copper and zinc. Yet more, the catalyst powder may comprise alumina powder.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows an example catalyst formation process of the current disclosure.

FIG. 2 shows how catalyst pellets of the current disclosure may be removed/influenced via a magnet.

FIG. 3 shows removal of catalyst pellets of the current disclosure from material, which may be biomass or other nonmagnetically active substances.

FIG. 4 shows the enhanced mechanical stability of an improved catalyst of the current disclosure.

FIG. 5 shows a schematic of one potential experimental setup of the current disclosure.

FIG. 6 shows XRD patterns of Cu/Al₂O₃ and Al₂O₃ catalysts.

FIG. 7 shows solid, liquid, and gas-phase yields at varying temperatures at: (a) 220, (b) 260, and 300° C. 198 with and without the presence of Cu/Al₂O

FIG. 8 shows reaction temperature increases when torrefied raw pellets were mixed with Cu/Al₂O₃ catalyst pellets

FIG. 9 shows heating values of corn residue pellets torrefied with and without the presence of Cu/Al₂O₃ catalyst at different temperatures of torrefaction.

FIG. 10 shows effects of the Cu/Al₂O₃ catalyst on O₂, CO, CO₂, and H₂ gases in gas-phase products during torrefaction at 260° C.

FIG. 11 shows one embodiment of a catalyst pellet with wire mesh almost completely enclosed within the catalyst material.

FIG. 12 shows another embodiment of a catalyst pellet where wire mesh substantially encloses outer perimeter of the catalyst material.

FIG. 13 shows yet another embodiment showing catalyst pellet with wire mesh employing rounded edges on the wire mesh.

FIG. 14A shows wire mesh that has been surface treated to improve catalyst adhesion.

FIG. 14B shows an alternate view of FIG. 14A.

FIG. 15 shows a wire mesh section after surface treatment.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of ±10% or less, ±5% or less, ±1% or less, and ±0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values the specified components in the disclosed composition or formulation are equal to 100.

As used herein, “water-soluble”, generally means at least about 10 g of a substance is soluble in 1 L of water, i.e., at neutral pH, at 25° C.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

Starting with a magnetic core, which in one instance may be a knitted magnetic steel mesh core, essentially any magnetic wire may be used for this application. A mesh core may be shaped in a spherical, oblong, polygon, pyramid, or other shape depending on the application of the catalyst. Indeed, the mesh core may simply be a random shape of “bunched together” mesh, which the catalyst integrates with. Although the current disclosure uses stainless steel, some grades of stainless steel are not strongly magnetic. Other feasible metals would be iron, nickel, chromium, or zinc, as well as combinations of these metals such as a copper/zinc blend, such as that of HIFUEL®. The current disclosure has developed a catalyst, which may comprise elements from Group 11 (Ib) of the periodic table, such as copper. Other useful metals include iron, chromium, molybdenum, tungsten, and rhenium.

Copper loading around 20 weight percent (wt %) supported on a γ-Al₂O₃ (Cu/Al₂O₃) shell. Other Shells Could Include Silica (SiO₂) Ceria (CeO₂), Titania (TiO₂), Or Graphene adhering to the steel core. The core/shell construct may be formed as described infra. Essentially, it revolves around forming a catalyst gel around a mesh before calcination or calcining the catalyst into a final powder and then pressing it in a hydraulic press. While 20% is used, the current disclosure is not so limited and weight percentages ranging from 5 to 95% are envisioned herein including subranges such as 10-90, 15-85, 20-80, 25-75, 30-70, 35-65, 40-60, 50-55, etc., as well as subranges within the above ranges. This catalyst has, for example, demonstrated excellent activity for A water-gas shift reaction at catalyst temperatures between 200-300° C. The Water Gas Shift is the reaction between carbon monoxide and water to produce hydrogen and CO₂ (CO+H₂O->CO₂+H₂)].

In order to form the Cu/Zn/Fe/Cr, or any other catalyst, via impregnation the alumina/ceria/titania or any other metal oxide support powder is added to water with the copper/zinc or any other metal salt (metal chloride, metal nitrate, metal acetate, etc.) and mixed until the solution is homogenous. It is then heated at ˜80-120° C. in air at atmospheric pressure until the majority or all of the moisture is removed and the copper/zinc or other metal is impregnated on the surface of the metal oxide support powder. For the case where the catalyst is formed via Route 3, described infra, the mostly dry powder is physically shaped by hand around a piece of the knitted metal mesh piece. This is then calcined/baked (300-600° C. at atmospheric pressure in air or oxygen for 2-12 hours) in an oven to form the final construct. For the Route where the catalyst is produced via hydraulic pressing then the powder is fully dried and then pressed with the metal mesh in the hydraulic press. A second procedure that we are currently using to produce catalysts is co-precipitation in which copper/zinc/iron/chromium/tungsten/rhenium salts are added to water alongside a precipitating agent (sodium carbonate, sodium bicarbonate, sodium hydroxide, ammonium carbonate, ammonium bicarbonate, ammonium hydroxide) either under air or nitrogen at 20-80° C. over the course of 1-3 hours which reacts with the copper/zinc/iron/chromium/tungsten/rhenium salts to form an insoluble precipitant/solid particle which is separated from water via vacuum filtration. This catalyst can either then be dried and formed as described previously or calcined at the same conditions as before and then hydraulically pressed with the metal mesh.

For a typical impregnation-based catalyst, we would typically use 7.1 g copper nitrate trihydrate with 7.4 g Al₂O₃ in enough water to make a slurry with the Al₂O₃ powder. For a wet impregnation catalyst with copper and zinc, we would use 5.48 g copper nitrate trihydrate with 3.27 g zinc nitrate hexahydrate and 5.0 g Al₂O₃ in enough water to make a slurry with the Al₂O₃ powder. For co-precipitation based catalysts, we would typically use 8.58 g copper nitrate trihydrdate with 10.3 g zinc nitrate hexahydrate and 8.3 g aluminum nitrate a nonhydrate that would be dissolved in water and then 11 g of sodium carbonate would be added drop-wise to cause the precipitation. A typical volume for this would be around 200 ml of water. Both of these Routes can be scaled up, and we have made larger batches. For the co-precipitation Route, we have made as much as a pound at once via scaling up these amounts proportionally. The catalyst is made by a wet impregnation of aqueous copper (II) nitrate trihydrate on alumina powder. Other copper salts could be used here, for example copper chloride, copper acetate, copper hydroxide, other metals and their corresponding salts can also include zinc, iron, chromium, molybdenum, tungsten, or rhenium. After reducing the solution volume via heating, the catalyst forms a paste-like consistency and can be mechanically shaped around a steel mesh core via the use of a mold to form consistently shaped and sized catalyst pellets. The catalyst is then dried and calcined.

Due to the presence of the steel core, the catalyst can be separated magnetically from a mixture of catalyst and other materials, for instance biomass, plant residue, etc. In general, the catalysts of the current disclosure have much improved mechanical stability and resistance to mechanical erosion. Additional mechanical stability is added via the inclusion of metal mesh on the outside or inside of the catalyst pellet. When on the inside of the pellet, it helps hold the catalyst together in a manner similar to rebar in concrete. When on the outside, it holds the catalyst together in a cage and the stainless steel takes forces from impact and flexes instead of objects or force hitting the hard catalyst pellet, which would break and chip under such conditions.

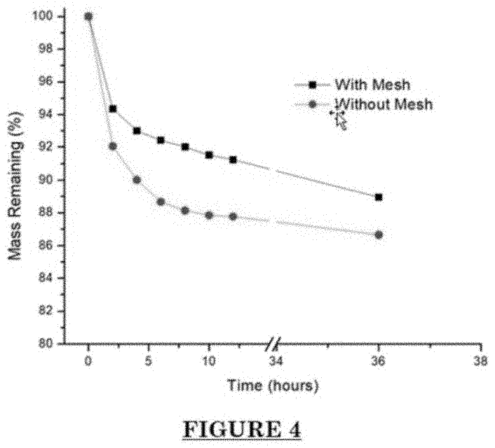

This improvement is shown in FIG. 4. For this test identical pellets were tested independently. For one set of pellets, they were encased in stainless steel and in the other case they were not. Less mass loss was seen with the pellets with mesh since the mesh added more mechanical stability as explained above. When mesh was not added, more mass loss was seen from the unprotected catalyst pellet as the mesh was not present. This enhances the catalyst's ability to survive harsh industrial conditions, for example in power plants with the presence of high-velocity fly ash.

In one embodiment, a Cu/Al₂O₃ catalyst was mechanically mixed with pellets produced from corn-based biomass for a biomass torrefaction process. In this process the catalyst with stainless steel is added to biomass (corn, wood, yard trimmings, or other agricultural waste) alongside the catalyst pellet. The biomass is torrified at 200-300° C. in combustion exhaust gas. As the biomass torrifies, it breaks down and releases CO, CO₂, and other hydrocarbon compounds. The catalyst reacts with water and CO to produce CO₂ and hydrogen removing the toxic CO from the outlet. After the torrefaction process (roughly 15-30 minutes) the catalyst with mesh is removed from the biomass via magnetic separability. This allows the catalyst with mesh to be recycled and reused in the process over and over. The combination of the catalyst with the biomass is novel and resulted in a 40-95% reduction of the CO concentration in the exhaust stream due to the water-gas shift and CO oxidation reactions occurring over the Cu/Al₂O₃ catalyst. The water-gas shift reaction also produces hydrogen, resulting in a valuable local hydrogen generation stream. After the torrefaction, the catalyst can be separated magnetically from the torrefied biomass.

The biomass torrefaction process in combination with the steel mesh based catalyst results in a process that improves the energy density of biomass, and cleans flue gas pollutants while simultaneously producing hydrogen resulting in both a savings in downstream exhaust cleaning and a potential revenue stream resulting from hydrogen production.

The catalysts described herein are based in one embodiment on a steel mesh, but other magnetically active materials may be used as well. Further, the mesh may be formed in a variety of shapes. The shape and size of the catalyst pellet will depend on the biomass fed with it. Too large of a size mismatch can cause settling of one component out and not make a good mixture of the catalyst with mesh and the biomass. One advantage of this process is that various shapes can be made via the physical molding process described in Route 3, which can tailor the size to the specific process conditions. The catalyst is magnetic and can therefore be easily separated from a process stream. In combination with biomass torrefaction, it reduces toxic emissions and produces hydrogen gas, which can be burned at the facility to generate heat or electricity. After the biomass torrefaction, the catalyst can be easily separated from the biomass using a magnet and subsequently reused in the process.

During the torrefaction of biomass, large amounts of toxic CO can be produced (up to 3-4 vol. %). A steel mesh based Cu/Al₂O₃ catalyst can be utilized to form CO₂ and H₂ (a value added product) from CO and H₂O in addition to oxidizing CO with O₂. The catalyst can be added directly to the biomass stream to perform the reaction in the torrefaction reactor without the need for a heated exhaust gas treatment unit after the torrefaction reactor, resulting in a cost savings. However, for this to be industrially viable, the catalyst must easily be mechanically separable from the biomass stream to facilitate reusing of the catalyst. By inserting a magnetic stainless steel mesh core or jacket into these catalyst pellets, it enables the entire pellet to be readily magnetically separable as well as imparting extra mechanical strength to the pellet itself.

Carbon monoxide oxidation catalysts are commonly sold for exhaust treatment applications from catalyst companies such as BASF, Catalytic Combustion Corporation, Johnson Matthey, Siemens, etc. Water-gas shift catalysts are sold commercially by AZO Materials (Reformance-WGS), Johnson Matthey (KATALCO and HiFUEL) among others.

Importantly, this catalyst can be added directly to biomass without the need for additional exhaust treatment infrastructure. It is easily separable as it can be readily separated via the use of a magnet. This catalyst oxidizes carbon monoxide while producing value added hydrogen gas. These factors allow for a less expensive torrefaction facility while simultaneously generating hydrogen which can be used for energy or the production of liquid fuels as well as ensuring the process can meet current emissions standards. Including a stainless steel mesh jacket or core results in the magnetic separability of the catalyst pellets from other non-magnetic materials present in a process stream such as biomass pellets. This assists in separability of the pellets from other materials which would be difficult to separate otherwise due to similarity in shape, size, and color.

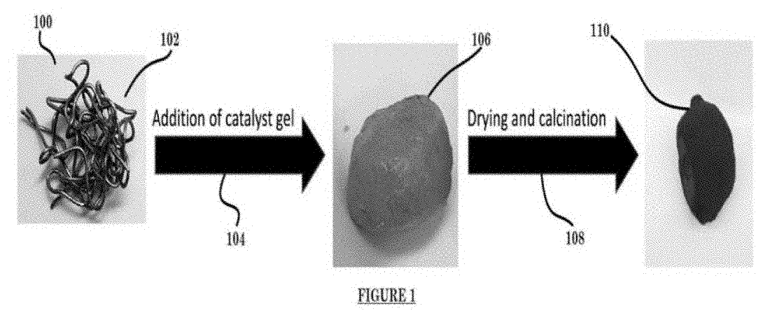

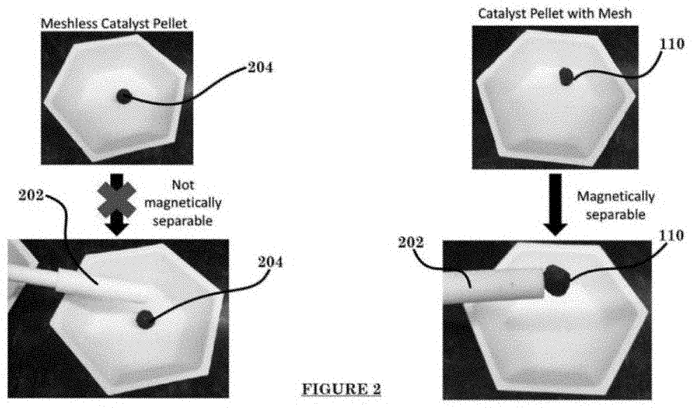

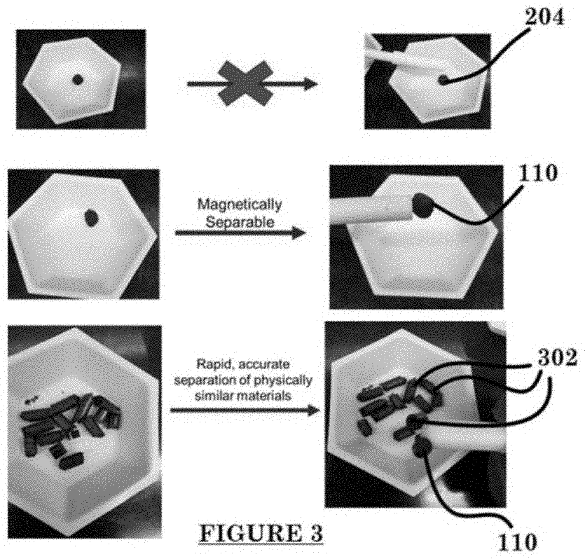

FIG. 1 shows an example process 100 of the current disclosure wherein a mesh 102 has catalyst added 104 to coat mesh 102 with catalyst gel 106, which is then dried and calcined 108, to produce catalyst pellet 110. As FIG. 1 shows, catalyst gel 106 may completely enclose mesh 102 so that no edges or portions of mesh 102 extend outside of catalyst gel 106 in both the “doughy” and final, calcined product. FIG. 2 shows how catalyst pellet 110 may be removed/influenced via a magnet 202 whereas a catalyst pellet 204, which is not magnetic, is not influenced via magnet 202. FIG. 3 shows removal of catalyst pellet 110 from material 302, which may be biomass or other nonmagnetically active substances, in order to provide rapid, accurate separation of pellet 110 from a production process, end-product, etc. FIG. 4 shows a graph demonstrating that magnetically separable catalyst pellets are more effectively removed than non-magnetically separable catalysts.

Multiple formation routes may be employed to create magnetically separable catalysts of the current disclosure.

Route 1 (Stainless Steel Mesh Core) is a procedure for making stainless steel mesh containing catalyst pellets from final catalyst powder (impregnation or co-precipitation based calcined powders). The process includes: (1) preparing the catalyst powder; (2) adding roughly half the required mass of catalyst powder to die press The required mass will depend on the size of the pellet die press. For small presses, this mass is roughly 20-50 mg but for larger pellet presses this could by 1 g or more; (3) adding a knitted stainless steel mesh disk to the middle of the catalyst powder Various knit styles may be employed. The main difference between the different styles boils down to the “tightness” of the knit which basically determines the space between the gaps in the knit. Knit methods may include knit stitches, purl stitches, yarn wrap, stiches, twisted stitches. Patterns of stitches may include, but are not limited to: garter, stockinette, 1×1 rib, 2×2 rib, 5×1 flat rib, 7×3 flat rib, seed, garter ribbing, broken rib, sand stitch, beaded rib, seeded rib, Andalusian, chevron, double fleck, double moss, hurdle, Irish moss, purl ridge, pique rib, waffle, little raindrops, flag, reverse ridge, tile squares, diagonal see, diagonal rib, long raindrops, pennant pleating, simple see, chevron rib, diamond brocade, seersucker, wide basket, caterpillar, classic basket weave, cut diagonals, pique triangle, basket loop, window stich, garter checkerboard, diagonal chevron zigzag, fancy diamond, embossed leaf, parallelogram, diagonal spiral rib, lattice seed, wide chevron zigzag, tumbling moss, large stacked triangles, etc. The mesh may also be a standard wire mesh forming squares, rectangles, circles, loops, or other shapes sized to hold a particular catalyst pellet. If the gaps in a mesh are too large, then the pellet can fall out. If the gaps are too small then none of the catalyst is exposed to the gas to react, so it depends on the size of the catalyst pellet used for the specific application. Common examples are commercially available as “knitted stainless steel mesh”; (4) add the remaining half of the catalyst powder to the die press; (5) press the formed pellet under desired load.

Load depends on the die employed. Smaller dies have lower pressures that can be used before the die fails. For example, some small dies fail at loads above 2-3 tons but larger dies can withstand much higher loads. The required load depends on the size of the desired pellet. Pellet diameters that could potentially be used with cylindrical pellets that are hydraulically pressed would range from 2 mm to 3 inches in diameter with aspect ratios (ratio of length to diameter of the pellet) of 0.5-5; (6) and remove the formed pellets from die press.

Route 2 (Stainless Steel Mesh Jacket/Sheathe) includes: (1) preparing catalyst powder; adding knitted stainless steel mesh jacket (in all Routes the mesh is the same type but can be changed based on the application and pellet employed. For example a mesh with a “tighter” knit for smaller pellets or using a cheaper metal mesh to lower costs) to die press; (3) add desired mass (The required mass will depend on the size of the pellet die press. For small presses, mass is approximately 20-50 mg but for larger pellet presses this could by 1 g or more) of catalyst powder to center of mesh jacket; (4) Press pellet under desired load (Load depends on the die. Smaller dies have lower pressures that can be used before the die fails. For example, the small dies we use fail at loads above 2-3 tons but larger dies can withstand much higher loads. So the required load depends on the size of the desired pellet.) and remove pellet from die press.

Route 2a (Stainless Steel Mesh Jacket/Sheathe) includes: (1) add desired mass of catalyst powder to die press; (2) press pellet under desired load and remove pellet from the die press; and (3) Knit stainless steel mesh around the pellet. Specialty knitting heads, such as those disclosed in U.S. Pat. No. 4,532,781 allow a mesh to be knitted and shaped around a solid mass, such as a pellet. This involves putting the catalyst pellet in a knitting machine and the machine knits metal around the pellet, similar to crocheting fabric around a small object except using metal wire around a catalyst pellet.

The current disclosure also provides procedures for making stainless steel mesh containing catalyst pellets from catalyst gel catalyst powder (impregnation based non-calcined powders only). This route produces constructs that are not necessarily cylindrical or spherical as most die presses are styled. Instead, this allows one to produce catalysts of essentially any shape needed. If a particular application needed non-standard shapes it can be physically molded to produce these shapes.

Route 3 (Stainless Steel Mesh Core) includes: (1) carrying out impregnation of catalytically active material on support material, see supra; (2) preparing a stainless steel mesh core (At this step, the knitted stainless steel mesh is cut to produce a size of mesh that is appropriate to the application. For example, if a 2″ long catalyst pellet is desired then the mesh is cut into a 2″ segment of that shape via scissors/shears or another cutting method); (3) Instead of drying powder fully, wait until the slurry resembles a gel-like state. The gel-like state may have the consistency of Play-Doh® or a similar substance, not sticky or especially wet but easily moldable while being able to retain its shape and can be determined via a “by-feel” observation of the gel itself. This typically occurs at the point where the majority, but not all, of the water has evaporated.; (4) Manually form the desired mass of gel around the stainless steel mesh core (this is accomplished by taking the catalyst gel and forming it around the mesh. Looking at 100 in FIG. 1, the interior gaps of the metal mesh are filled with catalyst gel and continued to be covered until all exposed wire is covered. Then additional material can be added by either physically molding it to the desired shape or putting it in a physical mold. For example putting the mesh into a square mold and then adding the gel then removing the mold and calcining the construct would result in a square pellet; and (5) calcine the catalyst gel with stainless steel mesh core to produce the final catalyst material This is carried out at atmospheric pressure in either air or pure oxygen at temperatures from 300-600° C. for times of 2-12 hours.

Route 4 (Stainless Steel Mesh Jacket/Sheathe) provides: (1) carrying out impregnation of catalytically active material on support material; (2) Instead of drying powder fully, wait until the slurry resembles a gel-like state; (3) Form a stainless steel mesh jacket of the desired pellet diameter (The advantage of physically molding the pellet means that essentially any shape or size can be used. The size should roughly be the same size of the biomass used in the process, such as from a 2 mm to 3-4 inches either as a standard cylindrical/spherical shape or essentially any shape that can be molded by hand or a dedicated mold; (4) manually form the desired mass of gel filling the mesh jacket, leaving some excess on the outside of the jacket to account for shrinkage (Roughly 10-20% excess can work. If no excess is provided then some shrinkage of the catalyst gel will occur during the drying and calcination due to loss of water and decomposition of the copper/zinc salts, etc. Thus, precursor and the mesh will stick out of the pellet and wires sticking could catch on other objects or poke operators; (5) calcine, as described herein, the catalyst gel with stainless steel mesh core to produce the final catalyst material.

Binders may also be used to help improve the stability of the catalyst pellets. Examples may include alumina, alumino-silicate clay, colloidal silica, polyvinyl alcohols, oleic acid, stearic acid, viscous polymers, clay, viscous plastics, Fuller's Earth®, BOEHMITE®, water, and simple alcohols, alone or in combination may be used. Preferably, the binders helps “wet” the pellet for pressing, lubricate the pellet and die allowing for easy separation of the pellet and die during extrusion, or increase adhesion between active particles to form a stronger pellet. For example, alcohols can be used for hydrophobic catalyst compounds and water for hydrophilic catalyst combinations.

Further, the surface of the wire mesh may be abraded or “roughed” in order to provide surface modifications to the wire mesh. This encourages catalyst adhesion. Possible methods include acid baths, physical abrasion, electrochemical surface roughening, etc. Anodic oxidation may be used as well and provides significant surface roughening. With severe treatment conditions, large channels and pits develop in the wire of the mesh. These channels and ridges provide additional surface area in which catalyst in the pellet can “grip” and adhere to increasing the strength of the pellet. This phenomena is similar to the texturing and spirals found on commercial reinforcing rebar increases the strength of rebar reinforced concrete.

One possible stainless steel knitted mesh that may be employed in the current disclosure is produced by Buck Enterprises LLC via a knitting machine as described in U.S. Pat. No. 4,532,781, which is hereby incorporated in its entirety.

### Enhanced Mechanical Stability Claims

Including a stainless steel mesh in the jacket of Route 2 results in less mass loss during simulated process testing when compared to a pellet without mesh. (This is shown in FIG. 4. Essentially, catalyst pellets are added to a tumbler with ball bearings to simulate abrasion. In this process, the catalyst pellets will collide with other catalyst pellets and/or biomass and process equipment. Loss of catalyst due to physical abrasion can contaminate the biomass with metals from the catalyst and cause catalyst loss, which reduces the lifetime of the catalyst and increases process costs for the end user.)

FIG. 4 shows example test conditions where 25 grams of total catalyst (5, 5 gram pellets) on a mesh-free basis were tumbled in a rotary tumbling machine for the specified amount of time at 37 revolutions per minute with 100 ¼″ stainless steel ball bearings. (In this testing, the pellets were added to a rotary tumbler with a drum 4.25″ in diameter (essentially a rock tumbler) along with ball bearings. Similar to a rock tumbler, the catalyst loses mass due to collisions with other catalysts and the stainless steel ball bearings added as abrasives. The reduced mass loss from the addition of the stainless steel is optimal here as it shows that the catalyst with the mesh is more physically stable and does not lose material due to abrasion at the same rate as a pellet without the knitted stainless steel mesh. This was performed at atmospheric pressure and temperature. Since only a few pellets were added, they were removed by hand. This test is not representative of what the catalyst will see in actual use but is essentially just an accelerated aging procedure used to test the claim of enhanced mechanical stability.

The catalysts of the current disclosure have direct field application and can provide numerous benefits in a torrefaction process. The effect of the addition of, for example, a Cu/Al₂O₃ catalyst on the product distribution of gas-phase products during torrefaction of pelletized corn residues was investigated at temperatures between 220 and 300° C. Pelletized corn residues were mechanically mixed with Cu/Al₂O₃ catalyst pellets. The mixture was then thermally treated in a fixed-bed reactor for 40 min of residence time at low temperatures of wet flue gas simulated by O₂ (4% v/v), CO2 (12% v/v), moisture (14% v/v), balanced with N₂. The higher heating value (HHV) of torrefied pellets was also examined within the operating conditions. It was found that torrefaction temperature affected the product distribution, yields, and HHV significantly, while the presence of Cu/Al₂O₃ catalyst pellets promoted the conversion of CO to CO₂ and the production of H₂ from raw biomass pellets via CO oxidation and water-gas shift reactions. This finding provides a favorable outlook for the energy utilization of pelletized agro-residues via torrefaction with wet flue gas as a pretreatment method, in which inexpensive catalysts could be applied to eliminate toxic gases and/or generate valuable hydrogen during the torrefaction process.

Biomass is a sustainable and renewable alternative to fossil fuels. The need to increase the share of energy production from renewable sources has been increasing and therefore, a more widespread use of agro-residues is expected. In Thailand, for example, agro-biomass, such as corn residues, is generated at about 10 million tonnes annually and has the potential to replace some existing fossil fuels. One of the most commonly used forms of energy production from agro-residue biomass is firing and co-firing of biomass in coal-based boilers. In such a case, the use of corn residues for fuels and/or energy also reduces the problem of air pollution which arises from burning the residues in the field.

In order to handle corn residues in terms of storage and transportation, raw corn residues are usually densified into uniformly sized solid shapes, such as briquettes or pellets, in which the volumetric energy density increases significantly from 200 kg/m³ for the original to 1000-1200 kg/m³ for the pellets. The pellets have a reduced moisture content of about 8-10% w/w on a dry basis. Currently, efforts to reduce greenhouse gas emissions and the rising oil and natural gas prices drive the rapid growth of the biomass pellet industry in the world and biomass pellets are being considered as a major transportable renewable energy source.

Biomass pellets can be improved via the torrefaction process. Torrefaction of biomass pellets can be carried out in the absence of oxygen at temperatures ranging from 200 to 300° C. During this process, the biomass pellets are partially decomposed, releasing various types of volatile compounds, and the fibrous nature of the biomass is destroyed, leading to torrefied biomass pellets which are much easier to grind. Also, the torrefied biomass pellets exhibit improved HHV and hydrophobicity. Compared to the original pellets, the HHV could be increased from 18.4 MJ/kg for the reference pellets to 24.4 MJ/kg for the torrefied pellets. In addition, the energy required to grind the torrefied biomass pellets could be reduced by a factor of ten from about 240 kWh/t of the raw pellet.

For co-firing of torrefied biomass pellets in a coal power plant, the torrefied biomass pellets can be produced on site with wet flue gas available from the power plant. This could improve the overall carbon efficiency of the power plant. Additionally, torrefaction of biomass pellets using power plant wet flue gas is practical, affordable, and environmentally sustainable, rather than using pure inert gas from compressed tanks. In the previous work, a computer simulation of a pulverized coal boiler in which torrefied biomass was fired instead of coal did not show significant changes in the boiler efficiency and the fluctuations of boiler load, but the net CO₂ and the NOₓ emissions were reduced significantly. Combustion behavior between coal and a mixture of coal and torrefied biomass was not different.

However, if wet flue gas is used to treat corn residue pellets to produce the torrefied pellets, toxic gases, such as CO, may be generated. To eliminate such toxic gases, catalysts can play a critical role. According to the literature, many catalysts, such as Cu/Al₂O₃, Pt/ZrO₂, or Fe/Pt/SiO₂ can be used to reduce CO in a gas stream at low temperatures. Among them, Cu/Al₂O₃ is widely used because of its high thermal stability, low cost, and high active surface area. With the Cu/Al₂O₃ catalyst, the water-gas shift reaction between CO and steam to yield H₂ and CO₂, is also promoted. This reaction occurs at temperatures between 180 and 250° C., which is also in the temperature range for torrefaction.

Using a Cu/Al₂O₃ catalyst for torrefaction of corn residue pellets may eliminate CO content in the gas-phase products and improve the quality of torrefied products. Torrefaction experiments were conducted in a fixed bed reactor at temperatures of 220, 260, and 300° C. with wet flue gas simulated by O₂ (4% v/v), CO2 (12% v/v), moisture (14% v/v) balanced with N₂, at 620 mL/min of total flow rate. The effects of varying temperature and the presence of the Cu/Al₂O₃ catalyst on the torrefaction were investigated for product distribution, yield, and heating values of torrefied pellets. The components of the gas-phase products were analyzed with mass spectrometry as a function of torrefaction time.

### Catalyst Preparation and Characterization

The Cu/Al₂O₃ catalyst was synthesized via wetness impregnation, with a nominal target loading of Cu at 20% w/w. Initially, the correct amount of copper nitrate trihydrate (Cu(NO₃)₂.3H₂O) was dissolved in distilled water, and then the aqueous solution was impregnated onto commercial gamma-alumina (γ-Al₂O₃), which was calcined at 600° C. for 3 h before impregnation. The resulting samples were heated at 120° C. until they were in the form of a gel. After that, the gel was mechanically formed into a pellet shape. The pellets were dried at 120° C. for 4 h, and then calcined at 450° C. for 12 h in an oven. A small batch of representative Cu/Al₂O₃ catalyst pellets was ground into a powder. X-ray diffraction (XRD) of the powder catalyst was carried out on a Rigaku Miniflex II Powder X-ray diffractometer with a CuKa source of radiation (α=1.5406) and a Si slit D/tex Ultra detector operated at 30 kV and 15 mA, in which data patterns were recorded within a scanning angle (2θ) range of 20-80° at a scan speed of 2° per min. As a reference, the γ-Al₂O₃ support was ground to a powder and also investigated with XRD.

### Experimental Setup for Torrefaction

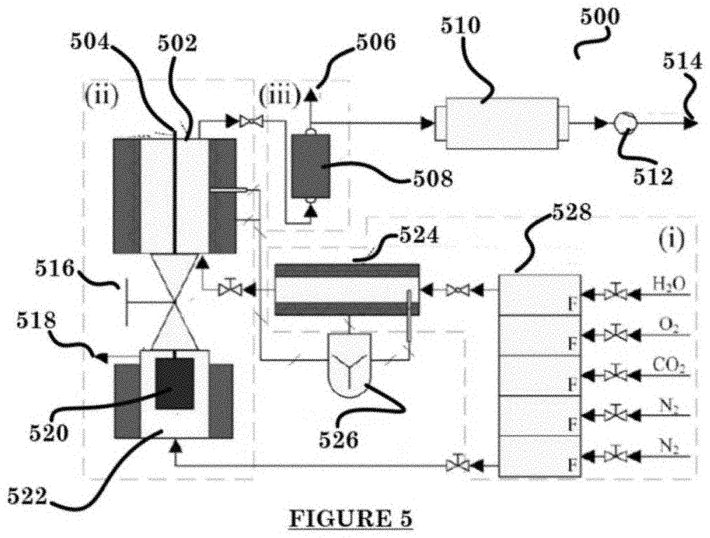

FIG. 5 shows one possible experimental setup for the torrefaction experiments, which were conducted in a fixed bed flow reactor. There are three units for the experimental setup—(i) a conditioning gas generator with mixer and heater: (ii) a main reactor for torrefaction; (iii) a condenser and a mass spectrometer (MS).

The conditioning gas was generated by mixing of CO₂, O₂, N₂, and water with flow rates controlled by Mass Flow Controllers (Brooks 5850E Series) and a HPLC Water Pump (Alltech Model 426), respectively. The conditioning gas was heated to a designed temperature of 220, 260, 300° C. in a mixer surrounded by a 500 W electric heater and a solid insulator, prior to being fed into the main reactor. The torrefaction reactor was made of cylindrical stainless steel with dimensions of 25.4 mm in diameter and 420 mm in length, in which heating and cooling sections were separated by a gate valve. The heating section was at the top of the gate valve. In this section, a 300 W electric heater was mounted circumferentially on the outside wall of the reactor and enclosed by a solid insulator. A K-type thermocouple was placed at the internal surface of the reactor. For the cooling section, water was circulated in a flexible tube, which was coiled on the external surface of the reactor. This was used to cool the pellet samples prior to and after each test. In the third unit, a small condenser vessel, was employed to trap any condensable products released from the reactor. The temperature of the condenser was maintained at 5° C. by cooling water, flowing in a flexible tube installed on its outside wall. The temperature of the lines between the reactor and the condenser was kept at around 150° C. in order to avoid the condensation of products.

For each test, 8 g of corn residue pellets and 2 g of Cu/Al₂O₃ catalyst pellets were mechanically mixed and loaded into the basket, which was initially positioned in the cooling section. The conditioning gas was generated by a mixture of high purity research grade CO₂ (12% v/v), O₂ (4% v/v), and N₂ (70% v/v) gases and water (14% v/v) at 620 mL/min of total flow rate. The temperature of the conditioning gas was increased to a set point for the torrefaction process to occur, and concurrently, the temperatures of the reactor in the heating section and the tube lined from the mixer to the reactor were also increased. After that, the basket with the sample in the cooling section was moved to the heating section and the gate valve was closed. The conditioning gas was fed to the reactor and the sample was treated and absorbed heat from the conditioning gas only. After 40 min, the gate valve was opened, and the sample was moved to the cooling section, where the conditioning gas was replaced with pure N₂, and the pellets were cooled for 30 min. The yields of solid, condensable, and non-condensable products are calculated from Eq. (1):

yᵢ=mᵢ/m₀×100 (1)

where y is a product yield at residence time of 40 min; % w/w on dry basis, in is the mass of each product represented by subscript i, and m₀ is the initial dried mass of the raw pellets. As a reference, a sample of corn residue pellets without the presence of Cu/Al₂O₃ pellets was also examined.

FIG. 5 shows a schematic of an experimental setup 500 of the current disclosure. The setup 500 may include torrefaction reactor 502, link 504, first outlet 506, condenser 508, mass spectrometer 510, pump 512, second outlet 514, gate valve 516, third outlet 518, basket 520, cooling section 522, gas heater 524, temperature controllers and data loggers 526, and flow controllers and mixers 528.

### Measurement of Gas-Phase Products

Non-condensable products were introduced to a mass spectrometer (HAL 201, Hiden Analytical Limited) for analysis. A leak valve was used to limit the total flow of the gaseous samples into the MS for a total pressure of 10-6 Pa. The concentration of each component was calculated by considering its raw and background signals, which were calibrated with respect to the standard gas.

### XRD Measurements

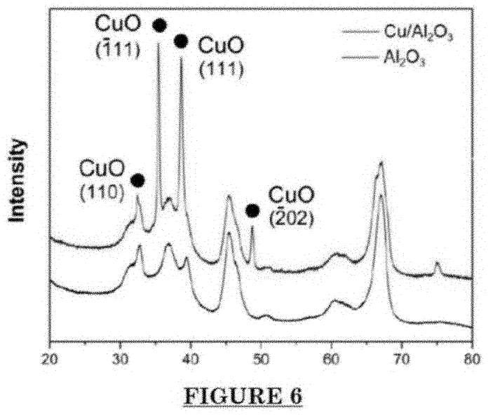

FIG. 6 shows the XRD patterns of γ-Al₂O₃ and the synthesized Cu/Al₂O₃ catalyst at a 2θ range between 20° and 80° taken with a scanning rate of 2° per min. As expected, the support material exhibited amorphous diffraction peaks characteristic of gamma-alumina (γ-Al₂O₃ ) at about 37.7°, 45.2°, 61.4°, and 67.7°. The Cu/Al₂O₃ XRD reveals the formation of single phase nanocrystalline CuO (JCPDS 80-1268) indicated by sharp peaks centered about 32.4°, 35.4°, 38.6°, and 48.7°, which are assigned to the (110), (T11), (111), and (202) crystal planes of CuO. Additionally, the support was not altered with the addition of Cu. The average crystallite size was calculated using Scherrer's equation and found to be 21.0 nm, similar to Azam et al.'s work. See, A. Azam, A. S. Ahmed, M. Oves, M. Khan, and A. Memic, “Size-dependent antimicrobial properties of CuO nanop articles against Gram-positive and -negative bacterial strains,” International Journal of Nanomedicine, vol. 7, pp 3527-3535, 2012. At the high temperatures of catalyst calcination, the oxidation possibility of Cu species, which have strong interaction with the matrix, increased and resulted in the crystallization of CuO particles, and consequently the four corresponding peaks of the nanocrystalline CuO phase appeared in the XRD patterns.

### Products Distribution and Yields

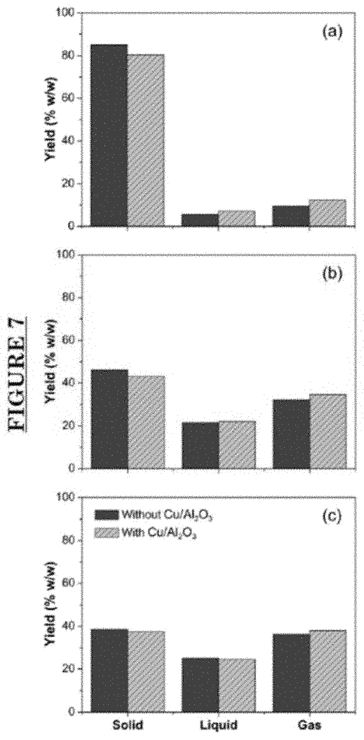

FIG. 7 shows the product yield as a function of torrefaction temperature with and without the Cu/Al₂O₃ catalyst pellets mixed with the corn residue pellets. It was clear that an increase in temperature and the presence of Cu/Al₂O₃ catalyst both caused lower yields of torrefied pellets, ranging from 15 to 60% w/w. The yield of torrefied pellets was, for example, about 85% w/w without the presence of Cu/Al₂O₃ catalyst pellets, and/or around 80% w/w with the mixing of Cu/Al₂O₃ catalyst pellets to the raw pellets at 220° C. But the yields of torrefied pellets was decreased to 40% w/w when the temperature was increased to 300° C. In contrast, both liquid and gas products increased with temperature and with the presence of the catalyst. The yields ranged between 3-30% w/w for liquid products and between 5-40% w/w for gas products, respectively, at the operating conditions.

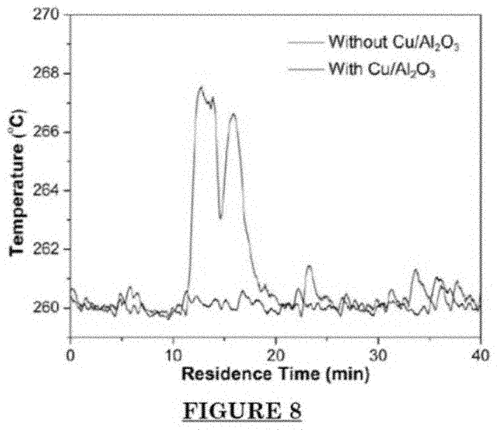

In view of increasing torrefaction temperature from 220 to 260 or 300° C., the greatest change in product yield occurred at 260° C. The yield of torrefied pellets dropped from ˜80% to 40-42% w/w, while the yields of liquid and gas products showed a significant rise from 3 to 20% w/w, and from 5 to 30-35% w/w, respectively. Nevertheless, both liquid and gas yields did not change significantly at higher temperatures when mixing catalyst pellets with the raw biomass pellets. This can be explained through the fact that dehydration, initial de-volatilization, and/or decarboxylation occurred during torrefaction. Unstable components in the biomass, such as cellulose and/or lignin, were decomposed to a higher degree when the temperature of torrefaction was increased, leading to lower yields in torrefied pellets and higher yields in both liquid and gas products. Likewise, the mixing of Cu/Al₂O₃ catalyst pellets with the raw biomass pellets caused a slight decrease in the torrefied pellet yields due to the catalyst possibly influencing the mechanisms of the decomposition. One indication of such interaction is shown in FIG. 8, where at a reaction temperature of 260° C., the temperature increased by about 8° C. in the case of catalyst pellets mixed with the raw biomass pellet sample.

### Analysis of Energetic Content

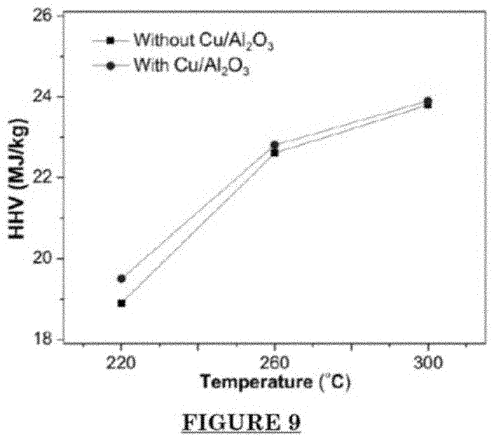

FIG. 9 shows the HHVs of the torrefied pellets at torrefaction temperatures of 220, 260, and 300° C., in which the torrefaction was performed with and without a mixing of Cu/Al₂O₃ catalyst pellets to the raw biomass pellets. The temperature of torrefaction was found to have a significant effect on the HHVs of the torrefied biomass pellets, more so than the presence of the catalyst mixed with the raw pellet samples. Compared to the original pellets (˜16.8 MJ/kg), an increase in temperature could improve HHVs of the torrefied pellets to about 24.1 MJ/kg. Particularly, when the temperature was increased from 200 to 260° C., the torrefied pellets improved their HHVs from about 17.6 MJ/kg to 23.2 MJ/kg. With the presence of the Cu/Al₂O₃ catalyst, the HHVs of the torrefied pellets was notably increased only at low torrefaction temperatures. In general, the HHVs of lignin are in the range of about 23.4-26.7 MJ/kg, while hemicellulose and cellulose are at about 215˜17.7-18.0 MJ/kg. The removal of hemicellulose and/or cellulose during the torrefaction can, consequently, induce a slight increase in the HHVs. Increase in torrefaction temperature causing higher HHVs of torrefied pellets was also reported by other authors.

### Components in the Gas-Phase

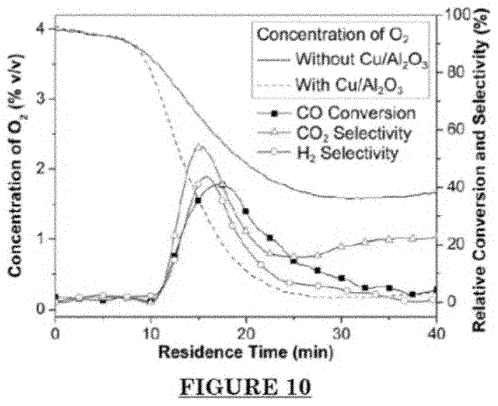

In order to gain insight into the effect of Cu/Al₂O₃ catalyst pellets on the torrefaction of corn residue pellets, the gas product components at 260° C., such as O₂, CO, CO₂, and H₂ were analyzed, see FIG. 10. Based on previous literature, torrefaction of corn residue pellets at this temperature condition could generate these gases via de-volatilization and pyrolysis. The mixing of the catalyst pellets with the raw biomass for the torrefaction was, however, found to cause reduced concentrations of O₂ and CO, but increased concentrations of CO₂ and H₂. The O₂ concentration was decreased markedly after 10 min of residence time and O₂ disappeared completely after 25 min. The change in the CO concentration was represented by relative CO conversion defined as the percentage of CO reduction with the presence of the catalyst.

In other words, a higher CO conversion refers to a lower CO concentration in the gas-phase products. Similarly, the change in CO₂ and H₂ concentrations was represented by relative CO₂ and H₂ selectivities, respectively. From FIG. 10, the relative CO conversion and the relative CO₂ and H₂ selectivities started to increase at 10 min of residence time, but the conversion exhibited a peak at about 18 min, which was about 3 min later than both selectivities. The conversion and the selectivities maintained constant values after 25 min of residence time. These behaviors occurred because the catalyst promoted the CO oxidation and water-gas shift reactions. With CO oxidation, CO released from the decomposition of biomass reacted with O₂ in the conditioning gas to yield CO₂ in the exhaust gas of torrefaction. This lowered CO and O₂ contents and increased CO₂ content in the exhaust gas. Concurrently, the increased CO₂ concentration could also be caused by the reaction of the CO with steam in the conditioning gas through the water-gas shift reaction. This mechanism would also explain the increase in H₂ concentration downstream. Additionally, the temperature increase in the torrefaction reactor, as mentioned supra, could be explained with CO oxidation and water-gas shift reactions due to their exothermic nature.

The Cu/Al₂O₃ catalyst was applied to the torrefaction of pelletized corn residues, carried out at 220 to 300° C. for 40 min with simulated wet flue gas consisting of O₂ (4% v/v), CO₂ (12% v/v), and moisture (14% v/v) balanced with N₂. Temperature of torrefaction was found to have a significant effect on the products' yields distribution and the heating values of torrefied pellets, more than the presence of the Cu/Al₂O₃ catalyst. The Cu/Al₂O₃ catalyst mixed with a sample of corn residue pellets can also reduce the content of CO and increase the content of H₂ in the exhaust gas of torrefaction. It was shown here that the utilization of inexpensive catalysts (e.g. Cu/Al₂O₃) in torrefaction of pelletized agro-residues with wet flue gas could be useful and practical in eliminating toxic gases such as CO and/or producing valuable gases such as H₂.

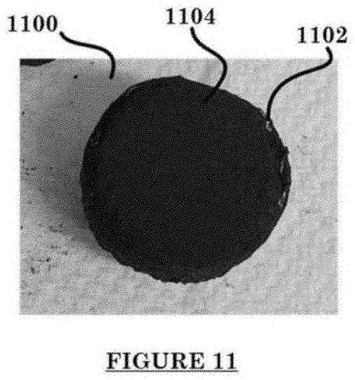

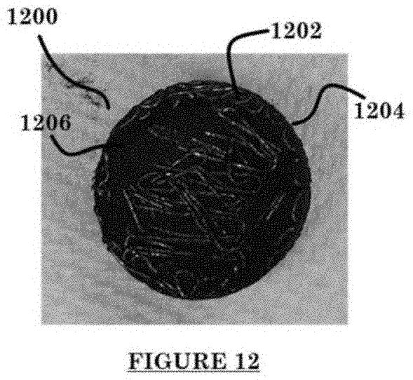

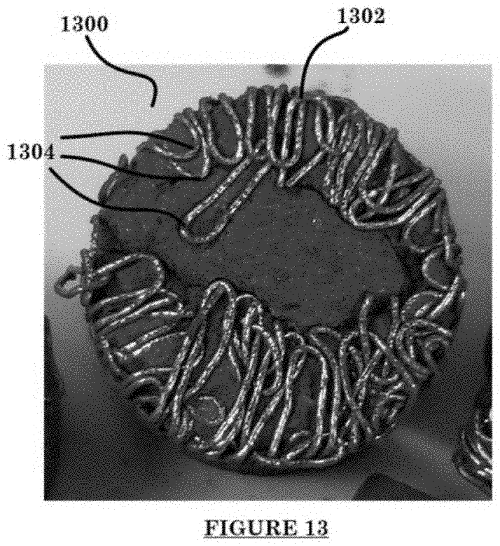

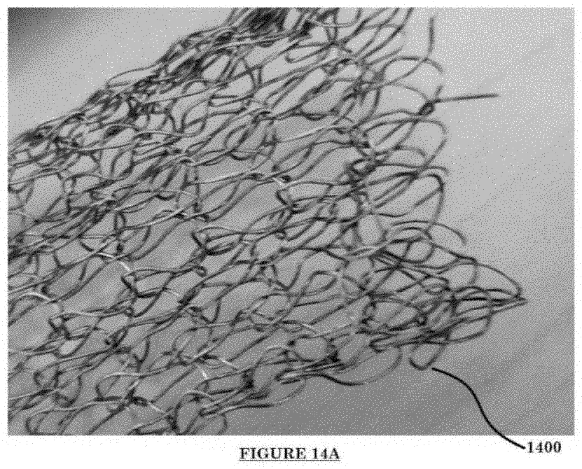

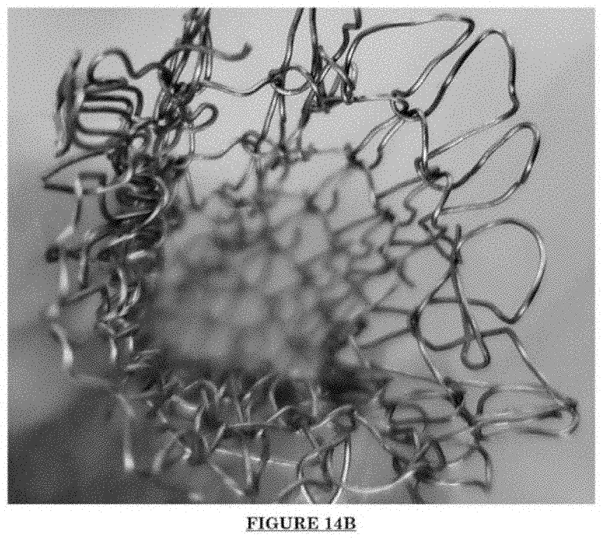

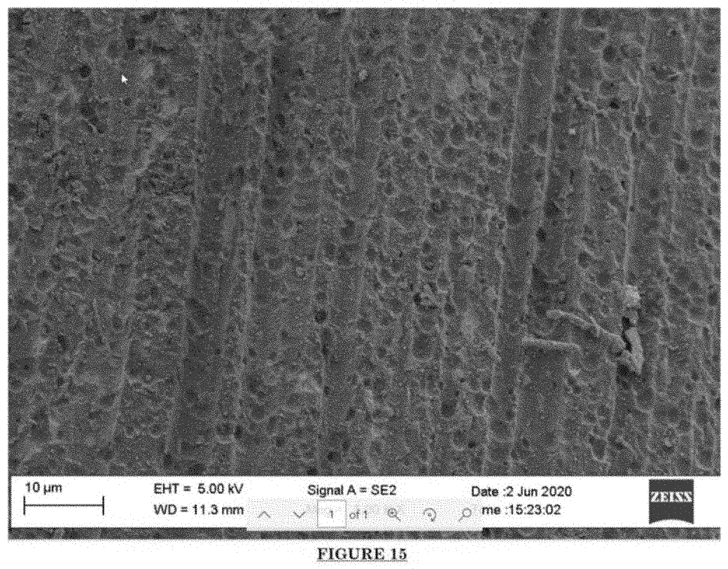

FIG. 11 shows one embodiment of a catalyst pellet 1100 with wire mesh 1102 almost completely enclosed within catalyst material 1104. FIG. 12 shows another embodiment of a catalyst pellet 1200 where wire mesh 1202 substantially encloses outer perimeter 1204 of catalyst material 1206. FIG. 13 shows yet another embodiment showing catalyst pellet 1300 with wire mesh 1302 employed rounded edges 1304 on wire mesh 1302 to help prevent snagging or catching on biomass or other catalyst pellets to prolong the useful life of catalyst pellet 1300. FIG. 14A shows one embodiment of a wire mesh column that may be employed with the current disclosure. FIG. 14B shows an end on view of 14A. The columnar wire mesh may have doughy catalyst inserted into the interior of the column or may be pressed or inserted into a body of doughy or wet catalyst. FIG. 15 shows surface abrading of a wire mesh to improve catalyst adhesion.

The catalyst system previously described is also useful in catalytic fluidized bed reactors or chemical looping reactors due the enhanced mechanical stability and/or magnetic separability of pellets with the knitted stainless steel core or jacket. In one possible implementation of this referred to as chemical looping combustion (CLC) or chemical looping oxygen un-coupling (CLOU), catalysts containing manganese, iron, copper, cobalt, aluminum, nickel, silicon, lanthanum, and/or strontium metals and/or their respective oxides can be encased in a stainless steel jacket or contain a stainless steel core, as previously disclosed, in order to increase the mechanical stability and impart magnetic separability of these catalyst pellets under the abrasive conditions experienced in a fluidized bed reactor due to frequent particle collisions. In this particular implementation, the metal oxide serves as an oxygen carrier to provide a nitrogen-free oxygen source for combustion of coal, natural gas, biomass, or other suitable hydrocarbon fuel source by releasing oxygen by being reduced from a metal oxide to a metal or lower oxidation state metal oxide. After releasing oxygen, this catalyst pellet would be cycled into a second reactor in which it reacts with air to re-form the metal oxide and can be cycled back into the fuel reactor for further use. These two reactors are spatially separated, and no gas mixing occurs between these two reactors. In essence this allows for oxygen to be indirectly supplied to a fuel from air without the need for nitrogen in the combustion reactor. In particular, this implementation can be deployed in tandem with the aforementioned biomass torrefaction application in which the oxygen supplied to the torrefaction process or for combustion of the torrefied biomass can be carried out by a highly mechanically stable, magnetically separable oxygen carrier to eliminate nitrogen in these processes. This allows for direct CO₂ capture, reduced equipment size/volume/cost, as well as virtual elimination of NOx formation.

In addition to this particular application, such a framework can be extended to a host of processes utilizing fluidized beds in which mechanical stability and/or magnetic separability are desirable characteristics. A non-exhaustive list of such applications includes fluidized catalytic cracking of hydrocarbons derived from petroleum or other feedstocks, fluidized catalytic upgrading of liquid hydrocarbon fuels or bio-oils, fluidized catalytic gasification of coal or biomass, fluidized catalytic production of plastics, rubbers, or other polymers, and fluidized catalytic exhaust gas treatment via oxidation of carbon monoxide, volatile organic compounds or other unburnt hydrocarbons and/or reduction of nitrogen oxides or sulfur oxides.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A magnetically separable catalyst comprising:
a magnetic mesh;
a catalyst integrated with the magnetic mesh; and
wherein the magnetically separable catalyst is specifically shaped under a load to form a final catalyst material that is magnetically active.

2. The magnetically separable catalyst of claim 1, wherein the catalyst comprises copper.

3. The magnetically separable catalyst of claim 2, wherein the catalyst comprises copper (II) nitrate trihydrate.

4. The magnetically separable catalyst of claim 3, wherein the catalyst comprises aqueous copper (II) nitrate trihydrate on alumina powder.

5. The magnetically separable catalyst of claim 1, wherein the catalyst is employed in a water-gas shift reaction at temperatures between 200-300° C.

6. The magnetically separable catalyst of claim 1, wherein the magnetic mesh comprises a specifically shaped mesh.

7. The magnetically separable catalyst of claim 1, wherein the magnetically separable catalyst is mixed with biomass.

8. The magnetically separable catalyst of claim 1, wherein the catalyst is shaped around the magnetic mesh.

9. The magnetically separable catalyst of claim 1, wherein the magnetic mesh is embedded into the catalyst.

10. A method for forming a magnetically separable catalyst comprising:
preparing a catalyst powder;
wet impregnation of the catalyst powder onto a magnetic mesh;
reducing solution volume via heating to form a catalyst gel;
mechanically integrating the reduced catalyst gel with the magnetic mesh; and
drying and calcining the mechanically shaped reduced gel.

11. The method of claim 10, wherein a mold is used to mechanically integrate the catalyst gel with the magnetic mesh.

12. The method of claim 10, wherein the catalyst is formed into consistently shaped and sized catalyst pellets.

13. The method of claim 10, wherein the catalyst comprises aqueous copper (II) nitrate trihydrate on alumina powder.

14. The method of claim 10, further comprising mixing the magnetically separable catalyst with biomass.

15. The method of claim 10, wherein the catalyst gel is shaped around the magnetic mesh.

16. The method of claim 10, the magnetic mesh is embedded into the catalyst gel

17. The method of claim 10, wherein the magnetic mesh substantially surrounds a perimeter of the catalyst gel once calcined.

18. The method of claim 10, wherein the catalyst powder comprises copper and zinc.

19. The method of claim 10, wherein the catalyst powder comprises alumina powder.
